(19) United States
(12) Patent Application Publication
(10) Pub. No.: US 2021/0295634 A1
(43) Pub. Date: Sep. 23, 2021

(54) Multifunction electronic handheld device

(71) Applicant: 4P Srl, Padova (IT)

(72) Inventor: Silvano Mansutti, Padova (IT)

(21) Appl. No.: 17/257,822

(22) PCT Filed: Jul. 16, 2018
(86) PCT No.: PCT/IB2018/055239

§ 371 Date: Jan. 4, 2021

(30) Foreign Application Priority Data
Jul. 12, 2018 (IT) 102018000007149

(51) Int. Cl. G07F 7/08; G07F 7/00; G07G 1/00; G07G 1/12; G06F 1/16

(52) U.S. Cl. CPC G07F 7/0886; G07F 7/005; G06F 1/1647; G07G 1/0081; G07G 1/12; G07G 1/0018

(57) ABSTRACT

A single body multifunction handheld electronic device includes a first display, a CPU, a working memory, an interface for data entry, and a second display arranged on a plane inclined with respect to the plane of the first display, and wherein the first and the second displays are properly and easily visible from two substantially opposite positions.

This patent relates to multifunction handheld computers and in particular concerns a new multifunctional handheld electronic device with dual display and printer.

Prior art comprises palmtop computers, that is, electronic devices with dimensions and weight that make them suitable to be held with one hand and be fully portable even during operation.

Said handheld computers typically include a plurality of peripheral devices integrated in a single box-shaped body, such as the data display, the keyboard for data entry, the CPU, working storage and mass storage devices.

Prior art also comprises handheld computers equipped with an integrated printer and one or more additional memory cards.

Depending on the intended use of the electronic device, it may also comprise further integrated accessories and peripherals. For example, the well-known electronic devices for the management of credit card and/or debit card (cashless) payments also comprise an interface for microchip cards based on contact or contactless technology and a display or touch screen area to enter personal identification numbers or to sign to complete the credit card transaction.

Said handheld electronic devices to manage payments typically have a single display to show the relevant data, and therefore provide for a limited use of the device itself, where the seller and the buyer must be side by side in order to simultaneously view the display, or the handheld device must be continuously rotated back and forth from the buyer's to the seller's position.

Handheld electronic devices are also known which have a second unit on the back equipped with a display and keyboard, or touch screen, for the sole management of electronic payments with magnetic cards and/or contact or contactless microchip-based cards.

Electronic table-top devices are also known in the prior art, equipped with two front-facing displays of considerable sizes and weights which do not permit mobile use such as with a handheld device.

The object of the present patent is a new type of multifunction handheld electronic device.

The main objective of the present invention is to make the device easier to handle and to use.

Another object of the present invention is to enable the person carrying the new electronic device, subsequently called user, and the person using the new device, subsequently called customer, to interact with the device without it having to change hands or be rotated back and forth from the user to the customer and vice versa and without the need for a support such as a table or a counter.

The present invention can also usefully be used in situations that do not involve sales, but for example for document control activities carried out by an inspector or conductor on a passenger of a transport vehicle or during the delivery of goods/documents by a courier/postal carrier.

A further object of the present invention is to integrate multiple functions in a single device, including for example those of a standard electronic computer, and the management and execution of electronic payments (cashless).

Still another object of the present invention is to integrate multiple functions in a single device, including for example, a cash register.

Yet another object of the present invention is to create a compact device by limiting the number of components.

These and other objects, direct and complementary, are achieved by the new multifunction handheld electronic device of the type comprising the following in a single box-shaped body: two displays, at least one CPU, at least one working memory, at least one interface for data entry, and where said two displays are arranged one facing the seller and one facing the buyer.

The new handheld electronic device is particularly suitable for use as a normal computer for the management of electronic payments (cashless) and also as a cash register.

In this regard, the new multifunctional palmtop device advantageously also comprises at least one housing with an interface for an unalterable fiscal memory device [DGFE—“Giornale di Fondo Elettronico” in Italian] for the secure recording of the receipts issued.

The housing equipped with an interface for the unalterable fiscal memory device may be, for example, conveniently located in the rear part of the device, for example in the battery compartment which is normally accessible by the operator and has no anti-tampering fiscal seal.

Alternatively, the aforementioned housing may be located inside the body of the new electronic device itself protected by an anti-tampering fiscal seal in the case of a cash register intended to transmit the transactions electronically.

The device also preferably comprises at least one integrated printer used to print orders and/or other non-tax related documents and/or to print receipts, in which case the printer is programmed, in a manner that cannot be changed by the user, to format receipts, that is, the size, font, the information to be printed, any possible tax logotype, while also recording the relevant data in the aforementioned unalterable fiscal memory device (DGFE), and the printing of the words “NOT FOR TAX PURPOSES” when non tax relevant documents are printed.

The new device may also be equipped with at least one sensor, such as an accelerometer, designed to disable or enable the operation of the printer respectively when the new electronic device is placed on a surface or is lifted and/or turned upside down.

The device also preferably comprises at least one unalterable fiscal memory device, and the relative housing integrated inside the casing not accessible from the outside of the device, said unalterable fiscal memory device being constrained inside the casing itself, and where the casing can only be opened if the anti-tampering fiscal seal is broken, for example a label on the casing of the new device, an electronic anti-tampering system, for example a sensor able to detect the opening of the casing and able to start the internal memory deletion procedure.

The new device comprises said two displays, subsequently called the first display and second display.

The first display is suitable for displaying content to the user.

The second display is suitable for displaying content to the customer.

Said first and second displays are mutually arranged so as to be visible and accessible when the user and the customer are facing each other and the new electronic device is placed between them. In this situation the first display is suited to display the information so as to be directly readable by the user, while the second display is suited to display the information so as to be directly readable by the customer.

The first display and the second display are arranged on two inclined planes, and where the inclination between the two displays is preferably fixed and predefined.

A practical application of the new device consists of the search for and entering of a purchase list by the user who sees the items on the first display.

When the order is entered, the purchase list can also be displayed on the second display or on a portion of the first display, so that the customer can check them simultaneously with the user and without the user having to pass the new device to the customer or the user and the customer positioning themselves side by side.

The second display may also display information and warnings of any kind.

Once the purchase is confirmed, the receipt printing procedure can be started, which may also be for tax purposes. In this case, during the printing procedure the product list and the partial amounts and the total are simultaneously displayed on the second display or on a portion of the first display.

This list with partial and total amounts may therefore be displayed on both displays but, in any case, at least on the first display.

In the case of electronic payments (cashless), instructions for the customer may also appear on the second display regarding payment with a credit or debit card simply by placing it near the second display, or by inserting it into the microchip reader, or sliding it through the magnetic reader depending on the supported card technology.

The customer may also pay with contactless devices such as NFC [near field communication] devices simply by bringing them closer to the second display.

The new device may also include at least one touch screen, which may be separated from each display or overlaid on all or part of each of these displays so that the customer can type in the PIN [personal identification number] or affix his signature while remaining in a frontal position with respect to the user using the device.

Said touch screen is, for example, useful for payment procedures or other procedures requiring a normal or graphometric signature or for entering a PIN.

Alternatively or in combination, the new device may comprise a keyboard to enter a PIN.

Said tactile function of the two displays can be activated when necessary or always active.

It is possible but not necessary for the second display, facing the customer, to have a film or a treatment or a layer suited to enable the second display itself to be viewed exclusively from the frontal position, preventing it from being seen from a lateral position. In an alternative embodiment the second display may be surrounded by a special raised frame that prevents what is displayed and/or typed on the touch screen of the second display to be seen from a lateral position.

Thus the new device enables the following applications by way of non-limiting example: operations for door to door sales, attempted sales, sales on board means of transport, such as on board aircraft, catering on-board trains, issuing fines, management of car parks, mobile ticketing, ticket or label verification in general, meter reading, cash/valuables-in-transit (CVIT), technical support at the customer's premises, express courier services and postal and delivery services in general, warehouse logistics, healthcare, hospitality, and municipal services in general.

The characteristics of the present invention will be better clarified by the following description with reference to the drawings, attached by way of non-limiting example.

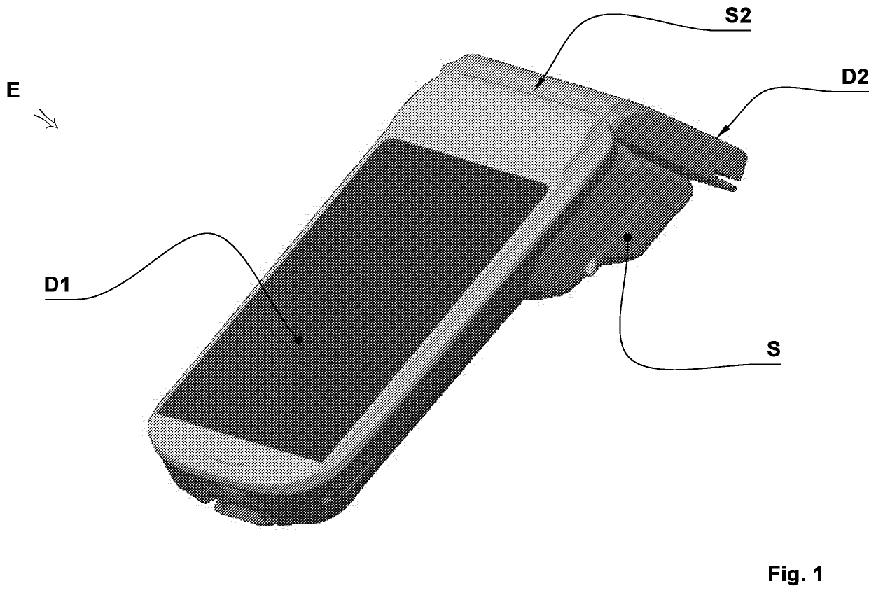

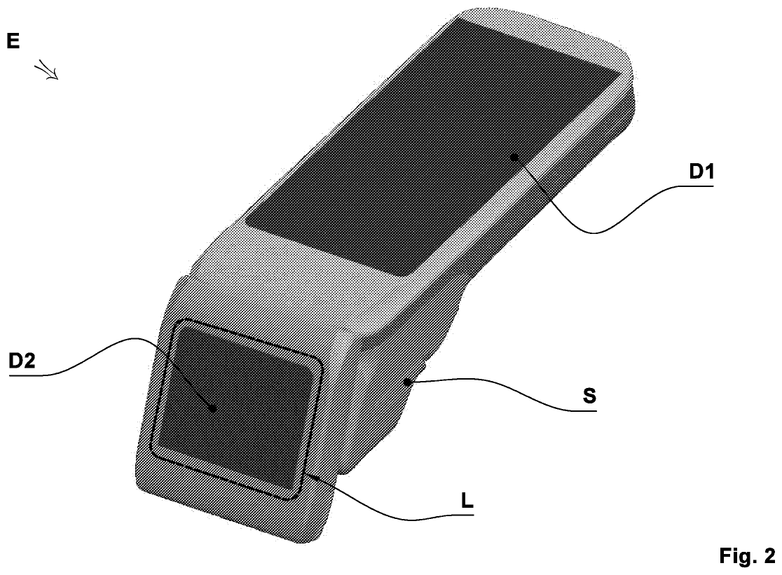

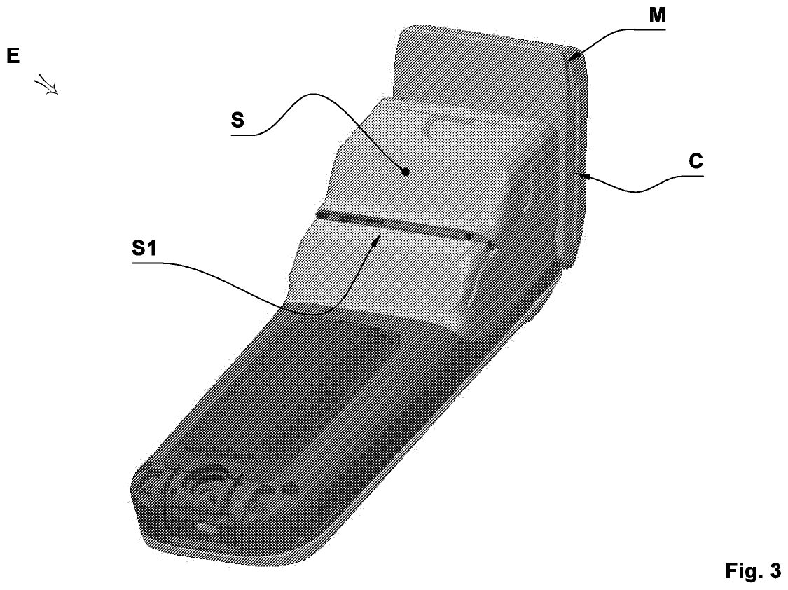

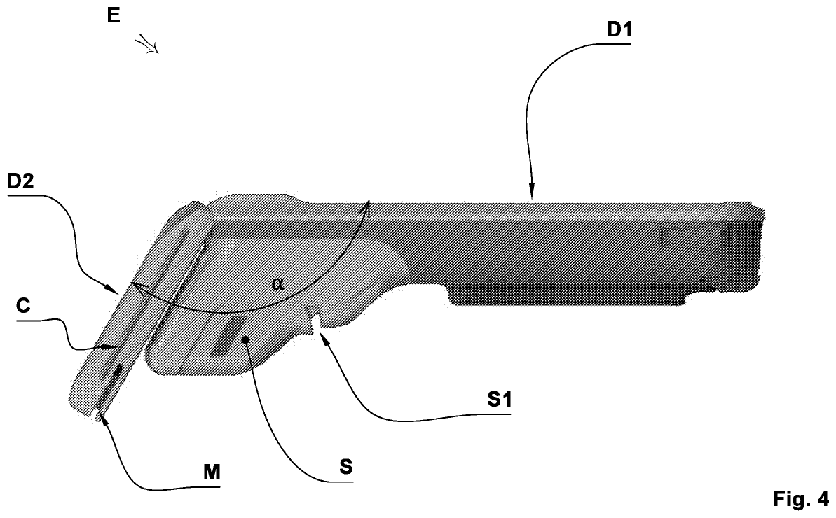

FIGS. 1, 2, 3 and 4 show respectively a representation of the new device (E) from the user's point of view, a representation of the new device (E) from the customer's point of view, a representation of the lower part of the new device (E), and a side view of the new device (E).

It is a multifunction handheld electronic device (E) comprising a first display (D1), a second display (D2), at least one CPU, and at least one working memory in a single body.

Said first display (D1) is suitable to display content to the user.

Said second display (D2) is suitable to display content to the customer.

Said first (D1) and said second (D2) displays are mutually arranged so as to be visible and accessible when the user and the customer are facing each other and the new electronic device is placed between them.

More specifically, the second display (D2) is inclined with respect to the plane of the first display (D1).

The angle (a) between the first (D1) and second (D2) display preferably ranges between 90 degrees and 180 degrees.

Each of the two displays (D1, D2) comprises a touch screen panel superimposed on the corresponding display (D1, D2).

The new device comprises a reader (M) for cards equipped with a magnetic strip, a reader (C) for cards equipped with contact microchips, and a reader (L) for cards equipped with contactless microchips.

The new electronic device (E) also comprises a printer (S) suited to issue sales receipts, generic receipts, invoices and the like.

In this embodiment the printer (S) is located in the lower part of the new device (E) between said first (D1) and said second (D2) display and comprises a slot or opening (S1) for the output of the printed paper.

The new device may also comprise at least one sensor or accelerometer so as to determine if it has been laid on a surface incorrectly and consequently prevent the printer from issuing the printed paper until the new device (E) is lifted and/or turned in the right position.

The printed paper output slot (S2) may be located on the upper part of the new device (E), between the first display (D1) and the second display (D2).

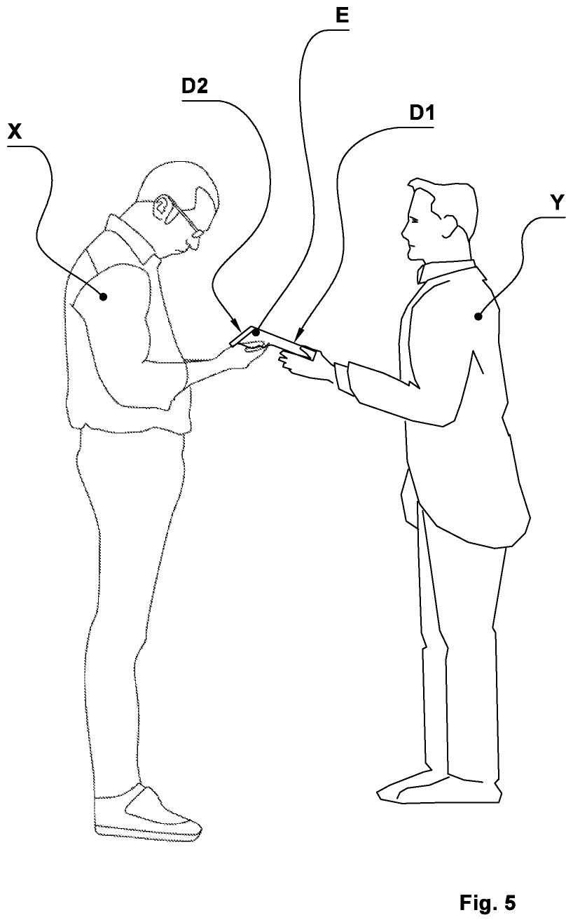

FIG. 5 shows an example of the use of the new electronic device (E), in which the user (Y) holds the new device (E) in his hand with the first display (D1) facing towards him and in such a way that at the same time the second display (D2) of the new device faces the customer (X).

These are the schematic outlines which are sufficient for the expert in the art to make the invention; as a result, in the practical application there may be variations without prejudice to the substance of the innovative concept.

Therefore, with reference to the preceding description and the attached drawings the following claims are made.

The invention claimed is:

1. A single body multifunction handheld electronic device comprising:
a first display;
a CPU;
a working memory;
an interface for data entry and display, and
a second display arranged on a plane inclined with respect to a plane of said first display,
wherein said first and said second displays are correctly visible from two opposite positions.

2. The single body multifunction handheld electronic device, according to claim 1, wherein said first and said second displays form an angle ranging from 90° to less than 180°.

3. The single body multifunction handheld electronic device, according to claim 1, further comprising a printer configured to issue fiscal and non-fiscal documents, wherein said printer is arranged below the single body of the multifunction handheld electronic device between said first and said second display.

4. The single body multifunction handheld electronic device, according to claim 3, wherein said printer issues said fiscal and non-fiscal documents from below said first and said second displays.

5. The single body multifunction handheld electronic device, according to claim 4, further comprising at least one sensor or accelerometer configured to determine if the single body multifunction handheld electronic device has been laid on a surface and, if so, to prevent the printer from printing documents until the single body multifunction handheld device is lifted and/or turned in a desired position.

6. The single body multifunction handheld electronic device, according to claim 3, wherein said printer issues said fiscal and non-fiscal documents through an opening on a top side with respect to said first and said second displays.

7. The single body multifunction handheld electronic device, according to claim 1, wherein said second display is designed to be viewed from a frontal position and to prevent said second display from being viewed from lateral positions.

8. c according to claim 1, further comprising a housing equipped with an interface for an unalterable fiscal memory device accessible from outside or inside of the housing and protected by an anti-tampering fiscal seal whether physical or electronic.

9. The single body multifunction handheld electronic device according to claim 1, further comprising an unalterable fiscal memory device, and a respective housing inside the single body that is not accessible from outside of the device, said unalterable fiscal memory device being constrained inside said single body, wherein said single body is configured to be opened only after breaking a physical and/or electronic anti tampering fiscal seal.

10. The single body multifunction handheld electronic device (E) according to claim 1, further comprising one or more of a magnetic strip card reader, or a contact or contactless microchip card reader.
